(19) United States
(12) Patent Application Publication
(10) Pub. No.: US 2014/0195358 A1
(43) Pub. Date: Jul. 10, 2014

(54) Managing Media Playback

(71) Applicant: CBS Interactive Inc., San Francisco, CA (US)

(72) Inventors: Jeffrey Martin Beining, Sunrise, FL (US); James Kong Hsu, Redwood City, CA (US); Christopher Peter Xiques, Oakland, CA (US)

(73) Assignee: CBS Interactive Inc., San Francisco, CA (US)

(21) Appl. No.: 14/210,215

(22) Filed: Mar. 13, 2014

Related U.S. Application Data
(63) Continuation-in-part of application No. 13/018,285, filed on Jan. 31, 2011.
(60) Provisional application No. 61/800,901, filed on Mar. 15, 2013.

(51) Int. Cl. G06Q 30/02; H04L 29/06

(52) U.S. Cl. CPC G06Q 30/0277; H04L 65/60
USPC 705/14.73

(57) ABSTRACT

Technology for managing playback of streaming media and ads associated therewith, is disclosed. Receiving a list indicating the location of ad pods in the stream and, optionally, indicating a list update time. Receiving instruction to play the stream forward from a seek point. Determining unplayed stream ads associated with locations from the list between the start and the seek point. Playing at least one determined ad. Optionally, playing at least one determined ad only upon determining that the list update time is greater than or equal to the seek point, otherwise, denying the seek point. Optionally after playing at least one determined ad, playing the stream from the seek point after playing the at least one determined ads. The list can be a list of cue points. Playing at least one determined ad can include playing the ad pod at the start of the stream section containing the seek point.

### CROSS REFERENCE TO RELATED APPLICATIONS

This application is a continuation-in-part of U.S. patent application Ser. No. 13/018,285, “Managing Media Playback”, filed Jan. 31, 2011, which claims the benefit of U.S. Provisional Patent Application No. 61/377,210, filed Aug. 26, 2010, the disclosures of which are incorporated herein by reference in their entirety. This application also claims the benefit of U.S. Provisional Application No. 61/800,901 entitled “Managing Media Playback” filed on Mar. 15, 2013 to Jeffrey Beining, James Hsu, and Christopher Xiques, the contents of which are incorporated by reference herein.

### FIELD

The technology disclosed herein relates to ad playback in streaming media. Some implementations of the technology have applications in management of ad playback in live streaming media.

### BRIEF DESCRIPTION OF THE DRAWINGS

Reference will now be made, by way of example, to the accompanying drawings which show example implementations of the technology.

FIG. 1 illustrates a streaming architecture according to one embodiment.

FIG. 2A illustrates a streaming architecture of the present technology according to one embodiment.

FIG. 2B illustrates an example architecture for implementing a cue point (CP) console running on an encoder.

FIG. 2C illustrates an example interface of the CP console for receiving encoded video information.

FIG. 2D illustrates an example interface of the CP console for creating an ad pod for playback in response to a player reaching a cue point in the stream.

FIG. 3 illustrates a timing chart of the streaming architecture of FIG. 1 and FIG. 2A according to one embodiment.

FIG. 4 illustrates methods of the present technology according to one embodiment.

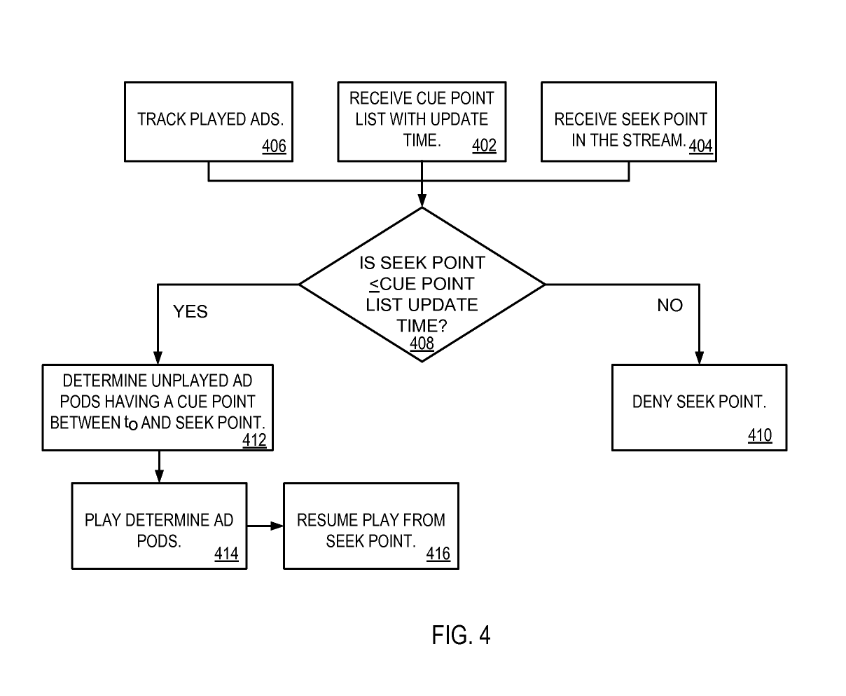

FIG. 5 illustrates a data processing architecture suitable for a non-transitory computer-readable storage medium storing a computer program product of the present technology and for executing the program code of the computer program product, according to one embodiment.

### DETAILED DESCRIPTION

Reference now will be made in detail to implementations of the technology. Each example is provided by way of explanation of the technology only, not as a limitation of the technology. It will be apparent to those skilled in the art that various modifications and variations can be made in the present technology without departing from the scope or spirit of the technology. For instance, features described as part of one implementation can be used on another implementation to yield a still further implementation. Thus, it is intended that the present technology cover such modifications and variations that come within the scope of the technology.

Embodiments relate to a computer-implemented method for managing playback of a stream of streaming media. A client device transmits a request to stream a stored media stream from a server, the media stream comprising requested media content. The media stream can be stored in association with an indication of a plurality of ad insertion slots, each ad insertion slot including a start time and stop time. The start time indicates a point in a timeline of the media stream for beginning playback of an ad pod and the stop time indicates a point in the timeline of the media stream for ending playback of the ad pod. In response to transmitting the request to stream the stored media stream, the client device receives from the server the stored media stream at a media player of the client device. Upon a playback position of the media stream encountering a start time of an ad insertion slot, the client device requests an ad pod to play during the ad insertion slot, the ad pod comprising one or more individual ads, and a duration of the ad pod corresponding to a duration between the start time and an end time of the ad insertion slot. The client device then receives the requested ad pod at the client device for playback, and upon completion of the playback of the requested ad pod, resumes reception of the media stream.

Streaming media can be multimedia that can be substantially continuously received by, and presented to, an end-user while being delivered by a streaming provider. “Streaming” refers to the delivery method of the medium rather than to the medium itself. The distinction is usually applied to media that are distributed over telecommunications networks, as most other delivery systems are either inherently streaming (e.g., radio, television) or inherently non-streaming (e.g., books, video cassettes, audio CDs). The verb ‘to stream’ is also derived from this term, meaning to deliver media in this manner. Internet television is a commonly streamed medium.

A media stream can be served to a client device either live or on demand. Live streams are generally provided by a means called true streaming. In true streaming, the client presents the media data substantially coincident with its receipt. For example, the client may present the media data without saving it to a permanent storage device (e.g., a hard disk drive). In on demand streaming, the client may receive portions (and potentially all) of the media file through progressive streaming or progressive download. In progressive streaming, the portions of the media file may be saved in storage at the media player and then may be played from that location. Additionally, on demand streams are often stored at servers and are made available for providing to clients for extended amounts of time; while live streams are typically available to clients at one time only (e.g. during a sporting event and for some period afterward). The client device may transmit a request to stream a stored media stream from a server.

During streaming of a live event, such as a sports event, an operator at the event generates cue point indicators for a “cue point console” that generates a metadata file (e.g., XML file) storing the relative timing of breaks in the event where ads should be inserted (e.g., during timeouts, halftime, etc) in broadcasts (e.g., video streams, television etc.) corresponding to the event. The metadata file stores, for example, the start time of a break, the end time of break, information about the type of break (e.g., timeout, halftime, overtime, etc.) and/or various other information. When the live event is streamed in real-time or at a later time, (e.g., after the event is over), the cue points are provided to the player together with the stream. Thus, the player can determine the relative timing of the breaks and how long they are and what type they are. During playback, the player observes the cue points and dynamically retrieves advertisements to insert into the stream during the determined breaks. To retrieve the advertisements, the player may transmit a request for an ad pod. The ads may be selected in order to appropriately fill the determined duration of the break (which may vary) and may also be selected differently based on the different types of breaks. The ads are retrieved from an ad database dynamically (rather than being stitched into the stream), so that ads can be selected that are particularly relevant to the user at the time of viewing. Once the ad pod has finished playing, the client device continues to receive the media stream.

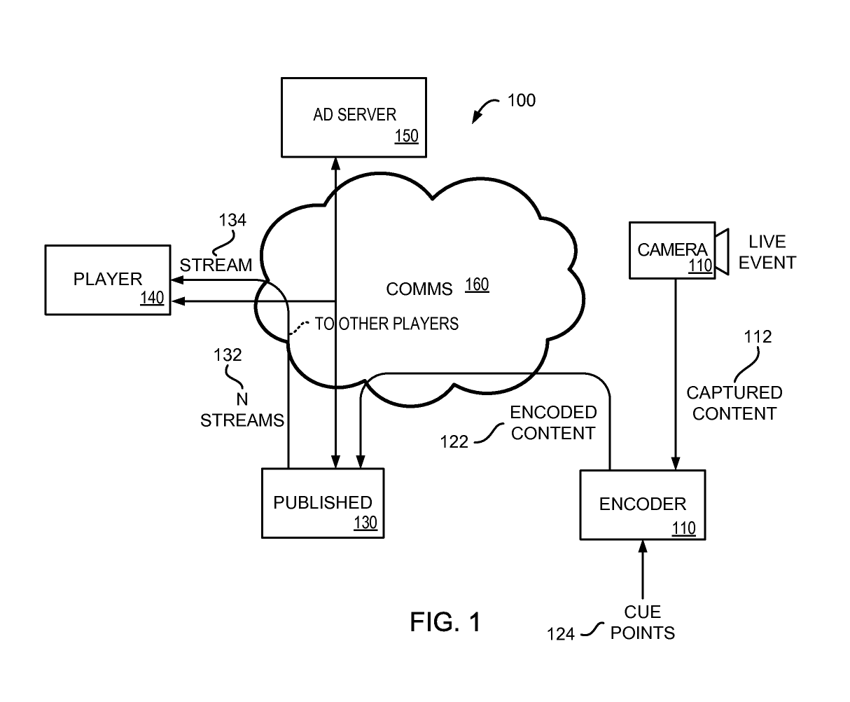

Referring to FIG. 1, a live streaming architecture 100 is illustrated. Live streaming technology can involve a camera 110 for capturing content of a live event. The live event can be characterized as starting at a start time, t₀, and scheduled to end at an end time, t_{end}. The current time (in relation to the start time) can be characterized as the time which content is being captured, t_{CAPTURE}. The camera 110 can communicate captured content 112 to an encoder 120.

The encoder 120 can process the captured content to create encoded content 122. The encoder 120 may also insert cue points 124 into the encoded content 122. A cue point 124 indicates the beginning of a time period for playing one or more ads. In one embodiment, the cue points 124 indicate an insertion point for an ad pod (i.e., a contiguous group of one or more ads) of a specified duration delivered by an ad server 150.

Typically, the encoding process requires some amount of time, even if the camera 110 and the encoder 120 are combined into a single device with hardware-driven solutions such as application specific integrated circuits. Consequently, the most current encoded content 122, which can be characterized as time t_{ENCODED} 340, may be delayed from t_{CAPTURE}. The encoder 120 may transmit the encoded content 122 to a publisher 130 via communications channels 160 such as the Internet or other telecommunications link.

The publisher 130 receives the encoded stream 122 that includes the encoded content and one or more cue point 124. The publisher 130 may archive and publish the encoded content through one or more streams 132 made available to users via player devices 140. A given published stream 132 provided to a user may include content at any point from the start time of the event, t₀, to the most recently published content at t_{PUBLISHED}. Additionally, stream access may be independently offered in a plurality of streams 132 such that a plurality of end users may each access different points of the stream 122 from t₀ to t_{PUBLISHED}. Thus, for example, if 20 minutes of content is published (t_{PUBLISHED} is 20 minutes from t₀), one user may access content starting from t₀, another user may access content starting from t₀+3 minutes, and still other viewers may access content from t_{PUBLISHED}.

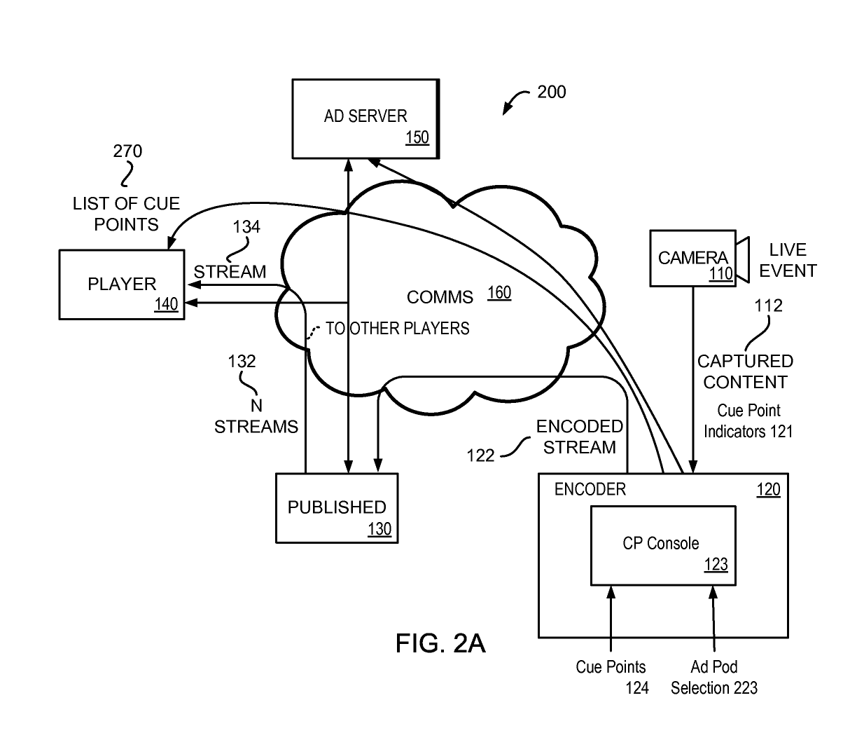

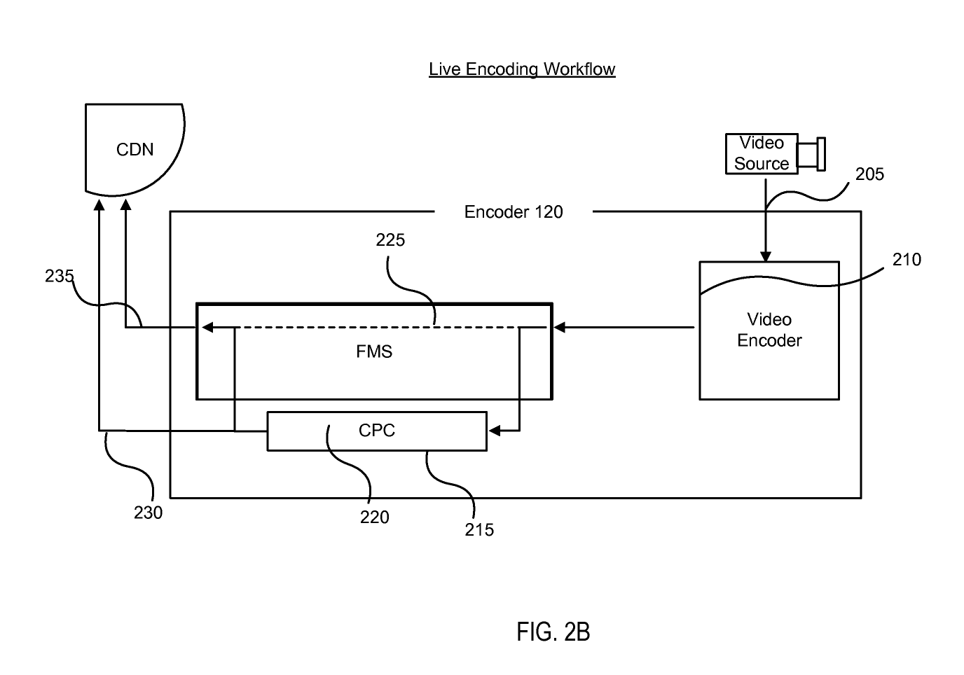

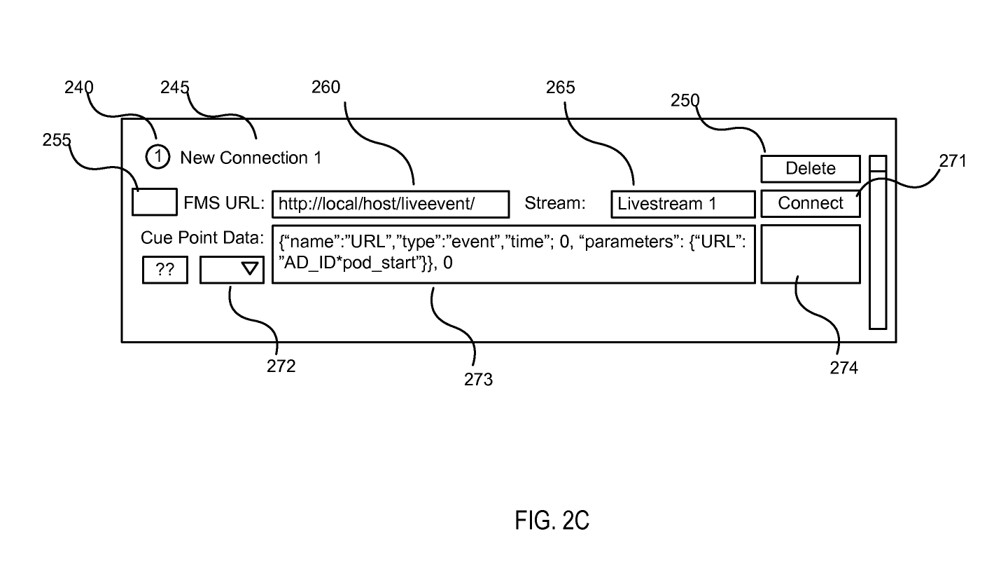

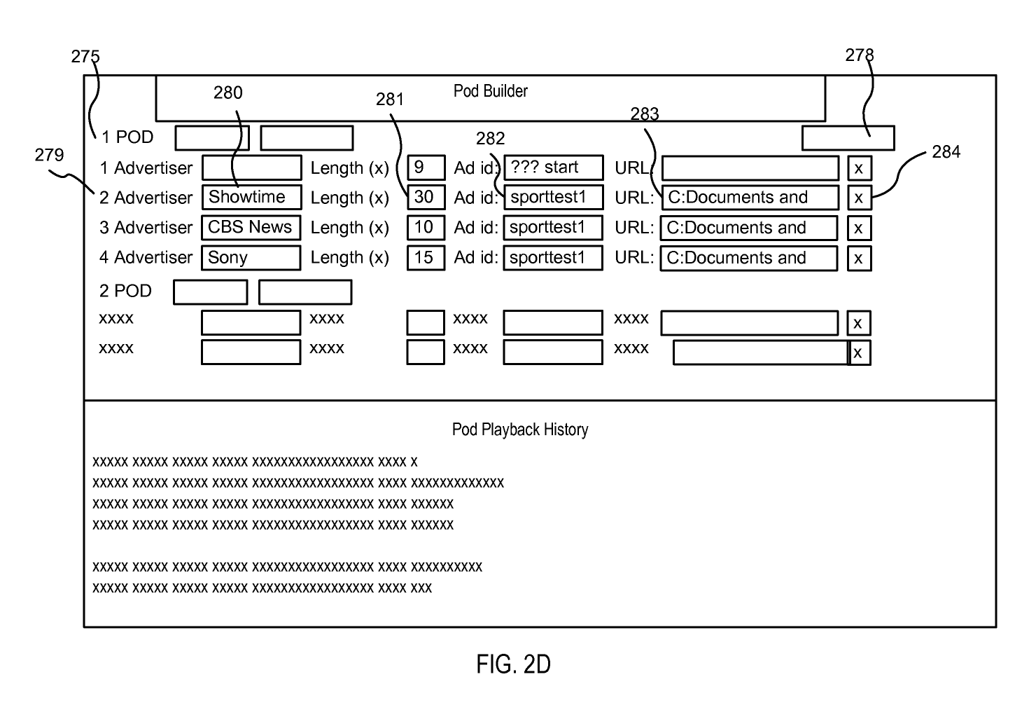

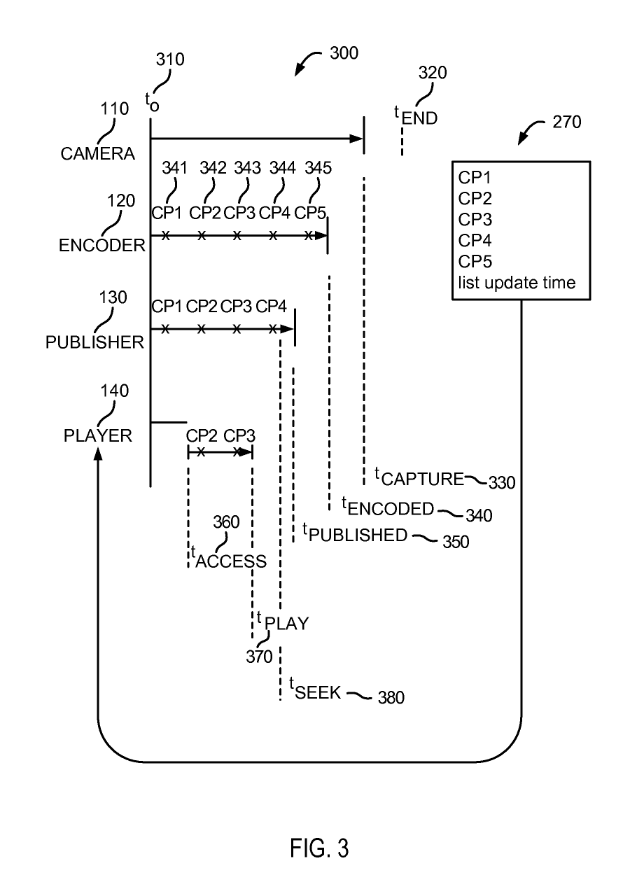

The publisher 130 may provide access to the captured content 112 via steams 132 for a fixed period after the live event ends. In some embodiments, such access can be offered through a content delivery network (CDN). Though a CDN is not explicitly shown in FIG. 1 and FIG. 2A, the CDN may be a separate entity or incorporated into the publisher 130. Since processes at the publisher 130 typically take some amount of time, t_{PUBLISHED} may be delayed from t_{ENCODED}. This delay may result in a period of time where cue points 124 (e.g., CP5 345 in FIG. 3) are encoded, but not yet published. /

In one embodiment, a user uses a player 140 to receive a stream 134 in the plurality of published streams 132 via communications channels 160. Via the stream 134, the player 140 may access any point in the published portion the encoded stream 122 from t₀ to t_{PUBLISHED}. The point accessed by the player 140 may be characterized by t_{ACCESS}. The player 140 may includes features such as a user interface wrapper allowing the user to interact with core player and the stream 134. The player 140, using technology familiar to those of skill in the relevant art or technology described herein, may render streamed 134 video content. The player 140 may additionally present ads during playback of the stream 134. For example, the player 140 may render one or more ads when it encounters a cue point in the stream 134 during playback (e.g., CP2 and CP3 as shown in FIG. 3). Presenting ads can include: retrieving specified ads from an ad server 150, playing the ads, and then returning to the stream or playing ads embedded in the stream by the publisher 130. The player 140 also can track t_{ACCESS} of the user to determine which cue points 124 were encountered and when the ads were played. The player 140 may additionally track which ad(s) or ad pod from the ad server 150 is played at a given cue point 124. Thus, for example, the player 140 may track that certain ads were played at CP2 and CP3 as shown in FIG. 3 and discussed in further detail below, and determine the time corresponding to ad playback at the CP.

The ad server 150 provides ads via communications channel 160 to the publisher 130 and/or player 140 for playback in streams 134 presented by the player 140. In one embodiment, the ad server 150 provides an ad pod that contains multiple contiguous ads. The ad server 150 may include different ad pods for different durations of ad playback that typically occur (e.g., set commercial breaks) during television programming. For example, the ad server 150 may include various 5 minute ad pods, 2 minutes ad pods, etc. The ad server 105 may determine the one or more ads placed in an ad pod based on rules specifying how and where the ads may be presented, desired delivery rate for the ads, and duration of the ads/ad pod. One example rule may specify whether the ad is an online ad, live ad, DVR ad, or combination thereof. Other example rules may include location where to, or where not to play a given ad, competitors that should not have ads played in the same pod, whether the ad may be played with other ads from the same advertiser in the same ad pod, and whether the ad should be played at the beginning, middle, or end of an ad pod. The rules may also include targeting variables that help the ad server 150 target the ad. For example, the targeting variables may include key words that can be matched/related to CCTV or other textual descriptions of the live stream. In a specific example, a fuel efficient car ad may have targeting variables such as “gas”, “budget”, “savings”, etc. which may indicate an advantageous time for presenting the ad.

In its most prevalent form, “time shifting” is the recording of programming to a storage medium to be viewed or listened to at a time more convenient to the user. The advent of the digital video recorder (DVR) has made time shifting easier, by using an electronic program guide (EPG) and recording shows onto a hard disk. Some DVRs enable other time shifting methods, such as being able to start watching the recorded show from the beginning even if the recording is not yet complete. Time shifting may allow users to fast-forward through ads, and some technology allows users to remove ads entirely. This feature has been controversial, with content providers claiming it violates copyright and should be banned. Hard drive-based DVRs, set top boxes, and software-based DVRs designed for home television recording, time-shifting, and ad skipping are known.

The streaming architecture described above facilitates time shifting for live streamed events that are not necessarily recorded by the end user. In the example streaming architecture, the encoded stream 122 may be distributed by the publisher 130 in N number of streams 132. As noted above, a player 140 may access any point from t0 to tPUBLISHED via a received stream 134 in the N streams 132. Consequently, for an event expected to be associated with thirty (30) minutes of ads, users viewing content streamed 134 from t0 thirty (30) minutes into the event will be able to skip viewing the ads by continually seeking to a point after each ad pod presented by the player 140.

Additional issues include difficulty in enabling the ad server 150 to determine which ad pod to select for a given cue point 124 when tPUBLISHED is proximate to tENCODED. Difficulty in determining an ad pod for presentation may arise during live events where the time between tPUBLISHED and tENCODED is less than, or proximate to, the duration of a cue point 124 relative to available ad pods. For example, if ads should be played throughout the duration of a break in action at a live event, the duration of an ad pod selected by the ad server 150 should match the duration of the break in action. For sufficiently long breaks, or a sufficiently short duration between tPUBLISHED and tENCODED, the overall duration of a cue point 124 (and thus the desired duration of the ad pod) may be unknown at the time the player 140 encounters the cue point or publisher 130 desires to embed ads in a stream 132. If the cue point is not fully specified by the time it should be fulfilled, the ad server 150 may fail to deliver a properly composed ad pod for presentation at the player 140.

Implementations of the present technology enable a player 140 to enforce ad playback when a user seeks the player beyond an unplayed ad in a published stream of a time shifted event. Additionally, implementations of the present technology enable the specification of cue point properties that a player 140, publisher 130, and/or ad server 150 use for presenting ads in live streams 132. While enabling implementations are described herein in the context of “live” time shifted streaming, the technology also has application to on demand streaming, and scenarios when ad positions beyond the last played ad are known. Additionally, while the ad server 150 determines the ad pod to play in the described embodiment, the publisher 130, player 140, or another entity may determine the ad pod to play in other embodiments.

Referring to FIG. 2A, a live streaming architecture 200 is illustrated. A live event can be captured by a camera 110 creating captured event data 112 that can be communicated to an encoder 120. The captured event data 112 can be encoded, and cue points can be added into the encoded stream at the appropriate times to signal the beginning of an ad pod. The encoder 120 can process the captured content to create encoded content 122. The encoder 120 may also insert cue points 124 into the encoded content 122. Cue points 124 indicate the beginning of a time period for playing one or more ads. In one embodiment, the cue points 124 indicate an insertion point for an ad pod (i.e., a contiguous group of one or more ads) of a specified duration delivered by an ad server 150. The encoded stream 122 can be communicated to a publisher 130. The publisher 130 can make the stream available to the player 140, and the player can join the broadcast at any point from t0 to tPUBLISHED, e.g., tACCESS 360.

Consider, for example, a sporting event that includes a variety of predetermined breaks and spontaneous breaks. Predetermined breaks occur when the live event goes to commercial for a predetermined period of time at a specified time in the event (e.g., to play a specific ad pod). For example, a live sporting event may go to commercial at the end of a quarter or period of play for a predetermined amount of time before coverage (e.g., the captured content 112 that is encoded) of the live event resumes. Oftentimes, an employee of the publisher 130 physically present at the live event signals the encoder 120 to go to commercial, and holds continuation (e.g., play of game, start of the next act or act, etc.) of the live event until the predetermined period of time passes. When the predetermined period of time has passed, and thus cue point duration may meet the requirement for playing the ad pod, the employee returns control of the live event. In some cases, the duration before coverage must resume (e.g., play of game) exceeds the predetermined break time. The difference is typically filled with improvised commentary and/or other captured content 112 rather than ads.

In contrast to a predetermined break, a spontaneous break occurs when the sequence of live events permits an unexpected opportunity to present an ad. For example, the stop of play during a sporting event due to player injury or time out may result in a spontaneous break. While some time outs may have a fixed duration (e.g., 30 seconds or 1 minute), they may also be considered spontaneous as the encoder 120 is unaware when they will occur and oftentimes of the duration the timeout was called for. Similar to predetermined breaks, the difference may be filled with improvised commentary and/or other captured content 112. Alternatively, an additional cue point may be specified. Consequently, one or more of the ads specified for playback may be cut short when transitioning back to live coverage.

In order to more effectively present ads in the context streaming 132 live events, properties of cue points 124 are determined in real-time based on input, or cue point indicators 121, received at the encoder 120 (e.g., from personnel at the live event and/or operating encoder) in response to activities associated with the live event. These cue pointer indicators 121 may be received by the personnel operating a cue point console, described in further detail below. Example cue point properties include a minimum duration, estimated duration, cue point start time (e.g., in relation to a timeline of the captured and/or encoded content), cue point end time, and cue point type (e.g., for a predetermined break or spontaneous break).

A cue point 124 itself may be created and included in the list of cue points 270 once an associated property has been determined. For example, the encoder 120 may create a cue point in response to the cue point indicator 121 providing a start time for the cue point 124. If the cue point 124 start time corresponding to a spontaneous of break of unknown duration, the start time may be stored and the cue point created. The end time may be left as undefined and updated once a stop indicator 121 is received. If the cue point 124 start time corresponds to a predetermined or otherwise expected break, the remaining properties of the cue point 124 such as duration and end time may already be specified. Accordingly, the cue point list 270 may be updated with the cue point and its properties. When a cue point indicator 121 specifying a stop time is received, the expected duration of the cue point may be updated based on the actual stop time. If the expected duration of the cue point 124 is exceeded (e.g., by 10 seconds), and still no cue point stop indicator has been received, the properties of the cue point may be updated to reflect that end time is undefined.

In implementations of the present technology, the list of cue points 270 and cue point properties determined at the encoder 120 may be contemporaneously communicated to the player 140 with the stream 134 rather than, or in addition to, those embedded directly in the stream. Thus, for example, the player 140 can receive updated lists of cue points 270 as the cue points and their associated properties are determined and inserted at the encoder 120 based on cue point indicators 121 captured contemporaneously with live content 112. The updated lists of cue point 270 and their associated cue point properties may also be communicated to an ad server 150. In one embodiment, the player 140 communicates the cue point properties when requesting an ad pod at a cue point.

The ad server may deliver an ad pod(s) when the player 140 reaches a cue point based on the properties of the cue point. For example, if the properties of a cue point specify a 2 minute duration, ad server 150 may select a 2 minute long ad pod. Matching the duration of the ad pods to the cue point in live streaming situations ensures that the player 140 does not lag behind the availability of video content in the published steam. If the player 140 encounters a cue point with an undefined end time, the cue point and associated properties may still be communicated to the ad server 150. The ad server 150, may, in turn, select an ad pod based on the start time, and the playback time of the player 140. For example, if the cue point 124 end time is not specified, the delay between the player 140 playback of the stream and the cue point start time indicates the minimum duration of a pod for playback for the cue point. Accordingly, the ad server 150 may select an ad pod meeting the minimum duration of the cue point. Should a selected ad pod be too short to fill the duration of the cue point (which may still be undefined), additional ad pods may be selected for delivery to the player 140 based on a new minimum duration determination (based on the end time of the previous ad pod playback).

The cue points may be stored (e.g., to an XML file) that tracks the locations of the inserted cue points relative to the stream. When the stream is presented by the player, the player observes the cue points at the appropriate points in the stream in order to dynamically insert ads. It can be seen that the ads may be more effectively inserted during real-time and playback, for example, when both a cue start time and cue point end time are known (as opposed to live operation when the end time may not yet be known). Thus, for example, the ad server may find an ad pod that is appropriate duration for the given cue point start time and end time.

In one embodiment, the list 270 of cue points may be created using a cue point (CP) console 123 at the encoder 120 and communicated to the player 140upon the player 140 joining the broadcast at tACCESS, upon receiving a request at the publisher 130 and/or player 140 from the user to seek to a different point in time in the stream, or in response to a cue point 124 and properties thereof being updated or added to the list by the CP console 123. The cue point console may be operated, for example, by an operator at a live event or at a production studio in order to insert cue points at appropriate times. For example, the operator may receive indications of a cue point start time to be recorded when a timeout of a live sports event is called, and may cause a cue point end time to be recorded when play is resumed. If the event is viewed in real time or later on (after the live event), these cue points can be used to indicate an insertion point for an appropriate ad, which may be included in an ad pod having a length between the start time and stop time, should both be defined.

The list 270 may be communicated to the player 140 and/or ad server 150 in a variety of fashions familiar to those of skill in the relevant art, including: Internet push technology; a publish/subscribe paradigm in which the player 140 subscribes to information published by the encoder 120, the publisher 130, or some other Internet host such as a server of a CDN; and polling by the player 140 upon initiation of access to or seeking within the stream 134. FIG. 2A illustrates communication directly from the encoder 120, though the communication can be from an intermediate Internet host (not shown) or forwarded to the player 140 by another entity such as the publisher 130. In either instance, the list 270 of cue points 124 is communicated to the player 140 and updated at the player throughout the time that the player 140 receives content via a given stream 134. For example, the list 270 received by the player 140 may be kept current, e.g., as a cue point is inserted by the CP console 123 at the encoder 120, a revised list 270 can be communicated to the player 140. In some implementations, the cue point list 270 includes an update time. The current version of the cue point list 270 can be made available to the player 140 independent of the player's 140 progress through the stream.

FIG. 2B illustrates an example architecture for implementing a CP console running on an encoder 120. In one embodiment, the encoder 120 is an encoding server 120 coupled to a network for delivering content and cue points. The video encoder receives 205 source video from the live event and encodes 210 the video. In some cases, the encoded video may be streamed to video player 140 in a container format, such as flash. In such cases, a media server (FMS) may convert 215 encoded video into streams in the desired container format. Should ads be inserted directly into the stream, the CP console 220 may retrieve and insert ads 225 in-line with the video stream. The encoded video (optionally in a container format) is then streamed 235 to the players. In other embodiments, the CP console monitors 225 the encoded video to determine locations in the video playback timeline for a cue point and specify cue point properties. For example, based on received 220 cue point indicators. The CP console, may in turn, provide 230 a list of cue points 270 and their properties to players receiving video 235.

FIG. 2C illustrates an example interface of the CP console for receiving encoded video information. As shown, the CP console may include a connection number 240 and connection name 245 indicating which connection provided information corresponds to and an option 250 to delete the connection. The monitor video output 255 selection may cause the CP console to display newly encoded video. The FMS server field 260 may be used to specify a media server which is providing the encoded video in a particular container format. The stream field 265 identifies the stream name of the encoded video and selection 271 provide the option to connect to the stream. The sync to tab 272 provides the operator with the ability to sync cue point insertion across multiple streams. For example, the sync tab may be used to provide the same ad pod across all active streams (and not necessarily for the same encoded video) at a particular time. The cue point data field 273 provides the ability to configure cue point properties. Send 274 causes the cue point and/or specified cue point properties to go live, i.e., be included in the cue point list 270 provided to the player 140. The send 10 operation may be triggered automatically based on received cue point indicators 121 e.g., when newly encoded video reaches the point in time corresponding to the moment when the indicator 121 was fired for the live stream.

FIG. 2D illustrates an example interface of the CP console for creating an ad pod for playback in response to a player 140 reaching a cue point in the stream. In other embodiments, the ad server 150 may automatically (or manually) specify ads for an ad pod. The ad pods may be stored as XML files providing details on which ads are included in the pod and any rules governing selection of the pod, e.g., duration, etc. The pod number 275 identifies the pod, and optionally a predefined cue point to which the pod corresponds, e.g., the 3rd period, 1st halftime ad, etc. The add marker selection 278 creates a new opening for an ad in the XML file of the pod and the marker number 279 identifies which position in the ad order the marker resides. 281 identifies the length of the ad 280 selected for a market in the ad pod. The ad id 282 indicates which ad is being played for the advertiser and 283 specifies the location of the ad (e.g., a URL or file location) for playback. Selection 284 enables to removal of an ad or end market.

The player 140 can receive input to seek to a point in the stream between time t0 and tPUBLISHED 404. For example, as illustrated in FIG. 3, the player 140 can receive instruction from a user to seek to tSEEK 370 after having played the stream from tACCESS to tPLAY. As the player 140 already played the stream from tACCESS to tPLAY, it will have encountered the cue points CP2 342 and CP3 343 having joined the stream subsequent to CP1 341 but not yet encountered published cue point CP4 344 and unpublished cue point CP5 345.

In those implementations of the technology including update time in the cue point list, the player 140 can determine if the seek point is to a time less than or equal to the cue point list up-date time 408. If the seek point is beyond the cue point list update time, then the player 140 may request an updated cue point list 270. If the seek point is still beyond the cue point list update time, the player may deny the seek point 410 and seek to the latest update time. In the example shown in FIG. 3, tSEEK<tUPDATE CUE POINT LIST 347, so the technology will not deny the seek point and will proceed.

In each implementation, the player 140 can determine the unplayed ad pods having a cue time between t0 and the tSEEK 412. For example, as shown in FIG. 3, CP2, CP3, and CP4 indicate unplayed ad pods between t0 and tSEEK.

The player 140 then can present at least one of the determined ads 414. In some embodiments, the ad pod at the beginning of the stream section containing tSEEK is played. Ads can be presented by implementations of the technology using methods known to those of skill in the relevant art. For example: ads in the ad pod can be retrieved from an ad server and played; the player 140 can seek to cue points in the stream 134 to play ads embedded in the stream. In some implementations, the player disables controls, e.g., seek, mute, minimize, while playing the ads. In some embodiments, “seek forward” is disabled. After playing the determined ads, the player can resume playback from the seek point 416.

The ad server 150 may monitor which players 140 are accessing the stream. In some embodiments, the cue point list 270 provided to the ad server 150 may instruct the ad server 150 to play a given ad pod for the next cue point encountered by any player 140 (or immediately) regardless of the players' access points in the stream.

As another example of implementations of the technology, consider a live event that has a planned duration of one (1) hour began at 1:00 p.m. and has been running for thirty-two (32) minutes. The player can enter the stream at that point and seek backwards in time to the 2-minute mark. At this point the player can present the archived stream thirty (30) minutes before the “live” point. Ads are scheduled to be presented every ten (10) minutes during this live event. An XML file representing the cue point history can be pushed to the player at the time the player entered the stream. In this example, the XML file will contain information for three (3) cue points: the one that occurred at the 10 minute mark, the one that occurred at the 20 minute mark, and the one that occurred at the 30 minute mark. If the player continues to play the archived stream, then eight (8) minutes in the first ad break will be encountered. The player can receive a message from the player's Flash NetStream object that a cue point has been encountered. The player can check whether this cue point has previously been made known through the pushed XML file. Alternatively, the player may monitor access of the video timeline and consult the XML file to identify cue times for cue points. If for some reason the player does not know about the cue point it can add the information about when the cue point occurred to the player's own list of cue point information.

At this point the player can send an event to notify the player skin that an ad(s) has started. The skin can then remove the progress bar user interface (UI) so that the user will not be able to fast forward and skip the ad(s). When all the ads to be shown at that ad break are finished, the player can mark in its list of cue point information that the ad has been played and it can send an event to the player skin alerting the skin that the scheduled ads have finished and the skin will reinstate the progress bar UI allowing the user once again to seek to different points in the archived stream.

In this scenario the player continues playing until the 27 minute mark in the archived stream. The player will now have played the ads that occurred at the 10 minute and 20 minutes marks of the archived stream. At this point the live event is now at the 57 minute mark. Cue points will have occurred in real time at the 40 and 50 minute mark. At each of these points in real time the cue point information can be updated and pushed to the player. The user now decides to seek ahead 20 minutes in time. This should position the player at the 47 minute mark in the archived stream—ten (10) minutes behind the live point. However, because the player has an accurate list of the cue points that have occurred in the live stream, the player can determine which ads were scheduled at the 30 minute and 40 minute marks. The player can determine the cue point immediately preceding the requested time, in this case the cue point at the 40 minute mark, or other cue point and confirm that the player has not played the ads for the selected cue point in the stream. The player can force the archived stream to seek to that position (or to a point just before that cue point). When the cue point is detected soon thereafter, the same chunk of code that was invoked earlier in the scenario can alert the skin that an ad is starting and the skin can disable the progress bar in the UI, so that the player plays the ad without responding to inputs to skip the ad. Once all the ads scheduled for the 40 minute mark in the stream have been played, the player will mark that these ads have been played and seek to the point in the archived stream (47 minutes) that the user initially requested.

After watching for another minute the user now attempts to seek backwards in time 10 minutes to minute 38:00 of the archived stream. Again the player can look at the cue point that occurred previous to this time, discover that the ads scheduled at that time (30 Minutes) have not been played and can seek to a point in the archived stream to play those ads. After the ads are played the player can seek to the originally requested time (the 38:00 mark).

Now the user attempts to seek back another ten (10) minutes in time (to the 28 minute mark). This time when the player examines the cue point previous to the requested time, it discovers that this set of ads has already been played and the requested seek is allowed. If the player continues to play another two (2) minutes, the cue point at the 30 minute mark will be encountered. Since these ads have been played, the skin application can, depending on the business rules of the skin, remove the progress bar UI and force the user to watch the ads again (alternatively, instead of repeating the previously played ads, the skin application may retrieve a new ad pod for playback), or keep the progress bar UI available so that the user can skip these previously viewed ads or make an internal seek request to the player to seek to the point in the stream just after this set of ads has completed.

In other embodiments, cue points can be used to specify particular types of breaks during events such as live sporting events. For example, cue points can label breaks as first timeout, second timeout, TV timeout, half-time, etc. Later when the event is played back, different types of cue points may dictate different choices of ads. Furthermore, different ad slots may be sold to advertisers at different prices. For example, a break associated with overtime may be sold at a premium.

In another embodiment, dynamic ads may be selected from available ad pods that are tailored to specific viewers, so that, for example, different viewers get different ads (based on, for example, known profiles or preferences of users). In other embodiment, certain ad slots may be “universal,” meaning that ever user gets the same advertisement regardless of the user. These types of universal ads may also be sold at a premium to advertisers. Furthermore, ads may be selected based on the timing of when the stream is watched. For example, a user who watches a stream before the Super Bowl may get a Super Bowl ad, but a user who watches the same stream after the Super Bowl is over will get a different more relevant ad.

In another embodiment, the player may display “companion ads” in addition to regular ads inserted into the stream. These ads may be dynamically selected based on cue points in the same manner described above. Companion ads may be displayed, for example, adjacent to the player or on a separate device (e.g., a second screen device).

The present technology can take the forms of hardware, software or both hardware and software elements. In some implementations, the technology is implemented in software, which includes but is not limited to firmware, resident software, microcode, a Field Programmable Gate Array (FPGA), graphics processing unit (GPU), or Application-Specific Integrated Circuit (ASIC), etc. In particular, for real-time or near real-time use, an FPGA or GPU implementation would be desirable.

Furthermore, portions of the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be non-transitory (e.g., an electronic, magnetic, optical, electromagnetic, infrared, or semiconductor system (or apparatus or device)) or transitory (e.g., a propagation medium). Examples of a non-transitory computer-readable medium include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized or distributed (or a combination thereof) as known to those skilled in the art.

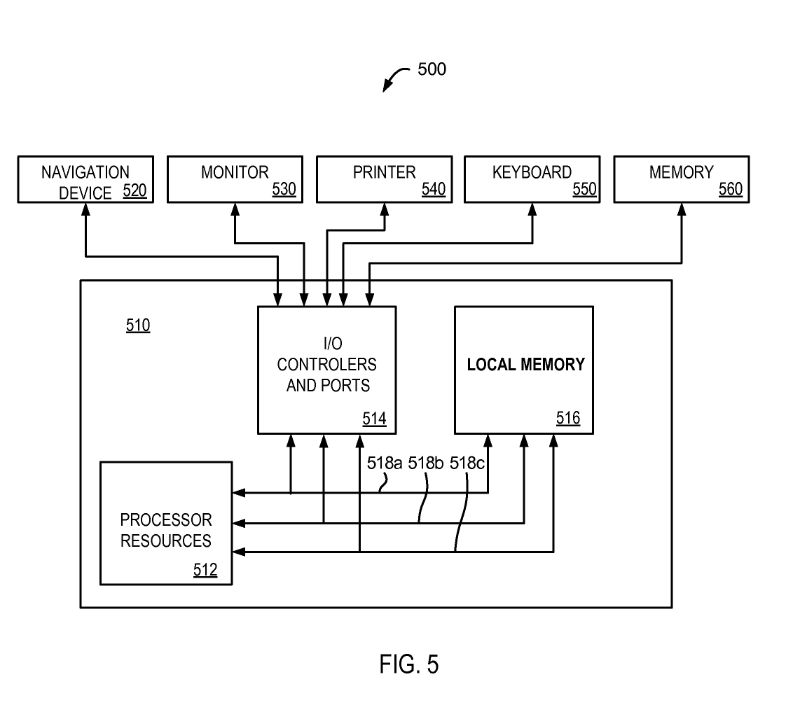

Referring to FIG. 5, a data processing system (e.g., 500) suitable for storing a computer program product of the present technology and for executing the program code of the computer program product can include at least one processor (e.g., processor resources 512) coupled directly or indirectly to memory elements through a system bus (e.g., 518 comprising data bus 518a, address bus 518b, and control bus 518c). The memory elements can include local memory (e.g., 516) employed during actual execution of the program code, bulk storage (e.g., 560), and cache memories (e.g., including cache memory as part of local memory or integrated into processor resources) that provide temporary storage of at least some program code in order to reduce the number of times code must be retrieved from bulk storage during execution. Input/output or I/O devices (including but not limited to keyboards 550, displays 530, pointing devices 520, etc.) can be coupled to the system either directly or through intervening I/O controllers (e.g., 514). Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some implementations, the data processing system is implemented using one or both of FPGAs and ASICs.

What is claimed is:

1. A computer-implemented method for managing playback of a stream of streaming media, the method comprising:
transmitting by a client device, a request to stream a stored media stream from a server, the media stream comprising requested media content, and the media stream stored in association with an indication of a plurality of ad insertion slots, each ad insertion slot including a start time and stop time, the start time indicating a point in a timeline of the media stream for beginning playback of an ad pod and the stop time indicating a point in the timeline of the media stream for ending playback of the ad pod;
in response to transmitting the request to stream the stored media stream, receiving from the server the stored media stream at a media player of the client device;
upon a playback position of the media stream encountering a start time of an ad insertion slot, requesting an ad pod to play during the ad insertion slot, the ad pod comprising one or more individual ads, and a duration of the ad pod corresponding to a duration between the start time and an end time of the ad insertion slot;
receiving the requested ad pod at the client device for playback; and
upon completion of the playback of the requested ad pod, resuming reception of the media stream at the client device.

2. The method of claim 1, wherein receiving the requested ad pod comprises:
receiving the requested ad pod having ads selected such that each of one or more individual ads are played a specified number of times within a predetermined period of time.

3. The method of claim 1, wherein receiving the requested ad pod comprises:
receiving the requested ad pod having ads selected based on one or more targeting variables, the targeting variables comprising key words related to one or more individual ads in the determined ad pod.

4. The method of claim 1, wherein receiving the requested ad pod comprises:
receiving the requested ad pod having ads selected based on a textual description of the media stream.

5. The method of claim 1, wherein receiving the requested ad pod comprises:
receiving the requested ad pod having ads selected based on a whether the individual ads are online ads, live ads, DVR ads, or a combination thereof.

6. The method of claim 1, wherein receiving the ad pod comprises:
receiving the requested ad pod having ads selected based on a geographic location of the client device.

7. The method of claim 1, wherein receiving the requested ad pod comprises:
receiving the requested ad pod having ads selected such that an advertiser associated with one of the individual ads in the determined ad pod is not a competitor of an advertiser associated with another of the individual ads.

8. The method of claim 1, wherein receiving the requested ad pod comprises:
receiving the requested ad pod having ads selected such that an advertiser is only associated with one of the individual ads in the determined ad pod.

9. The method of claim 1, wherein receiving the requested ad pod comprises:
receiving the requested ad pod having ads selected based on whether the individual ads should be played at the beginning, middle, or end of an ad pod.

10. The method of claim 1, wherein receiving the requested ad pod comprises:
receiving the requested ad pod having ads selected based on a known profile of a user of the client device.

11. A computer-implemented method for managing playback of a stream of streaming media, the method comprising:
storing a media stream at a server for subsequent playback, the media stream comprising requested media content;
storing in association with the media stream, an indication of a plurality of ad insertion slots, each ad insertion slot including a start time and stop time, the start time indicating a point in a timeline of the media stream for beginning playback of an ad pod and the stop time indicating a point in the timeline of the media stream for ending playback of the ad pod;
receiving a request to stream the stored media stream;
upon receiving the request to stream the stored media stream, transmitting the stored media stream to a media player of a client device;
upon a playback position of the media stream encountering a start time of an ad insertion slot, determining an ad pod to play during the ad insertion slot, the ad pod comprising one or more individual ads, and a duration of the ad pod corresponding to a duration between the start time and an end time of the ad insertion slot;
transmitting the determined ad pod to the client device for playback; and
upon completion of the playback of the determined ad pod, resuming transmission of the media stream to the client device.

12. The method of claim 11, wherein determining the ad pod to play during the ad insertion slot comprises:
selecting the determined ad pod based on one or more targeting variables, the targeting variables comprising key words related to one or more individual ads in the determined ad pod.

13. The method of claim 11, wherein determining the ad pod to play during the ad insertion slot comprises:
receiving a textual description of the media stream; and
selecting the determined ad pod based on one the textual description.

14. The method of claim 11, wherein determining the ad pod to play during the ad insertion slot comprises:
selecting the determined ad pod based on a whether the individual ads are online ads, live ads, DVR ads, or a combination thereof.

15. The method of claim 11, wherein determining the ad pod to play during the ad insertion slot comprises:
selecting the determined ad pod such that an advertiser associated with one of the individual ads in the determined ad pod is not a competitor of an advertiser associated with another of the individual ads.

16. A non-transitory computer readable storage medium, the computer readable storage medium storing instructions that when executed by a processor cause the processor to perform steps including:
transmitting by a client device, a request to stream the stored media stream from a server, the media stream comprising requested media content, and the media stream stored in association with an indication of a plurality of ad insertion slots, each ad insertion slot including a start time and stop time, the start time indicating a point in a timeline of the media stream for beginning playback of an ad pod and the stop time indicating a point in the timeline of the media stream for ending playback of the ad pod;
in response to transmitting the request to stream the stored media stream, receiving from the server the stored media stream at a media player of the client device;
upon a playback position of the media stream encountering a start time of an ad insertion slot, requesting an ad pod to play during the ad insertion slot, the ad pod comprising one or more individual ads, and a duration of the ad pod corresponding to a duration between the start time and an end time of the ad insertion slot;
receiving the requested ad pod at the client device for playback; and
upon completion of the playback of the determined ad pod, resuming reception of the media stream at the client device.

17. The non-transitory computer readable storage medium of claim 16, further storing instructions that when executed by the processor cause the processor to perform steps including:
receiving the requested ad pod having ads selected based on one or more targeting variables, the targeting variables comprising key words related to one or more individual ads in the determined ad pod.

18. The non-transitory computer readable storage medium of claim 16, further storing instructions that when executed by the processor cause the processor to perform steps including:
receiving the requested ad pod having ads selected based on one the textual description.

19. The non-transitory computer readable storage medium of claim 16, further storing instructions that when executed by the processor cause the processor to perform steps including:
receiving the requested ad pod having ads selected based on a whether the individual ads are online ads, live ads, DVR ads, or a combination thereof.

20. The non-transitory computer readable storage medium of claim 16, further storing instructions that when executed by the processor cause the processor to perform steps including:
receiving the requested ad pod having ads selected such that an advertiser associated with one of the individual ads in the determined ad pod is not a competitor of an advertiser associated with another of the individual ads.
